(19) United States
(12) Patent Application Publication
(10) Pub. No.: US 2004/0243361 A1
(43) Pub. Date: Dec. 2, 2004

(54) Systems and methods for providing mass customization

(75) Inventors: Eric Anthony Steuben, San Jose, CA (US); Emory Merrill Wright IV, Santa Cruz, CA (US); Kent G. Verdis, San Francisco, CA (US); Srinivas Kaza, Santa Clara, CA (US); James C. Culp, Pleasanton, CA (US); Leonard M. Hedge, Pleasanton, CA (US)

Correspondence Address: Bao Tran, Align Technology, Inc., 881 Martin Avenue, Santa Clara, CA, 95050, US

(73) Assignee: ALIGN TECHNOLOGY, INC., Santa Clara, CA

(21) Appl. No.: 10/224,538

(22) Filed: Aug. 19, 2002

(51) Int. Cl. G06F 17/50

(52) U.S. Cl. 703/2

(57) ABSTRACT

A method for mass-customizing a product by fitting a first object by generating a virtual model of the first object, altering the virtual model to generate a transformed virtual model, and generating a second physical object from the transformed virtual model.

### BACKGROUND

The present invention relates to systems and methods to perform mass customization. Mass customization may be defined as a delivery process through which mass-market goods and services are individualized to satisfy a very specific customer need. Based on the public's growing desire for product personalization, it serves as the ultimate combination of “custom-made” and “mass production.” Mass customization is about choice; about giving consumers a unique end product when, where and how they want it.

Unlike mass production, which produces some variety of an item in high volumes, mass customization is characterized by small volumes—in many cases, lot sizes of one. It is also characterized by competitive cost, timely deliveries and a move away from centralized manufacturing to more distributed production. Consequently, when combined with the very latest digital technology, such as e-commerce and robotics, mass customization not only benefits the consumer, it offers the manufacturer significant benefits as well: a high degree of product/service flexibility, reduced inventory risk, and a competitive edge in the marketplace.

### BRIEF DESCRIPTION OF THE DRAWINGS

FIG. 1 is a diagram illustrating an exemplary mass customization system.

FIG. 2 is a diagram of an exemplary system for generating an object at a 1.

FIG. 3 is a flowchart illustrating an exemplary process for treating patient.

FIG. 4 is a flowchart illustrating an exemplary process for treating the patient's teeth at the professional's office.

FIG. 5 shows an exemplary system supporting patient treatment using the Internet.

FIG. 6 is a flowchart of a process for selecting dental services from a patient's perspective.

FIG. 7 is a flowchart of a process for providing dental services from a treatment provider's perspective.

FIG. 8 is a diagram of a system for manufacturing appliances.

FIG. 9 is a diagram illustrating a computer system to support the fabrication of appliances.

### DETAILED DESCRIPTION OF THE INVENTION

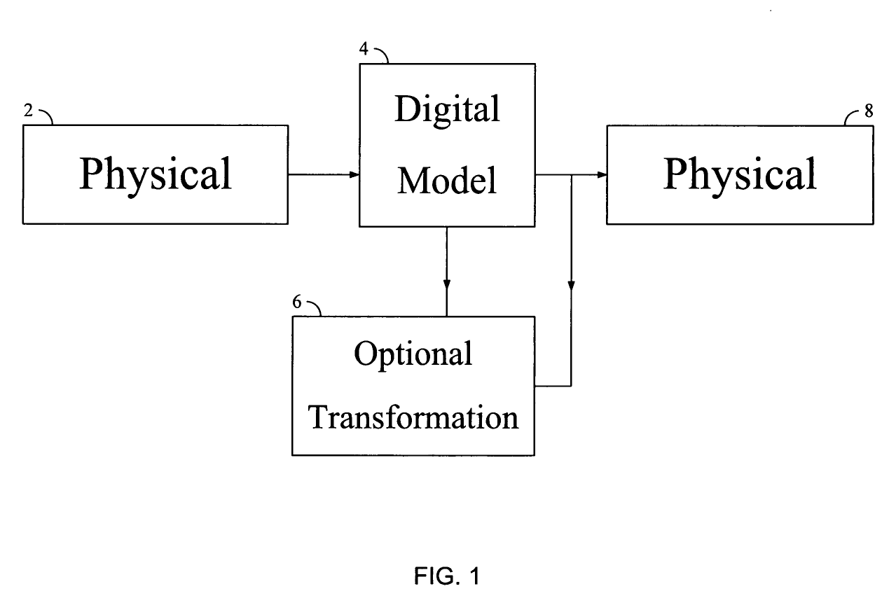

Referring now to FIG. 1, a diagram illustrating an exemplary mass customization system is shown. In FIG. 1, a physical object 2 is converted into a digital model 4 using a suitable scanner, as discussed in more details below. The digital model 4 can optionally be transformed in a transformation block 6. The original or transformed digital model is then converted back into a second physical object 8 or series of physical objects.

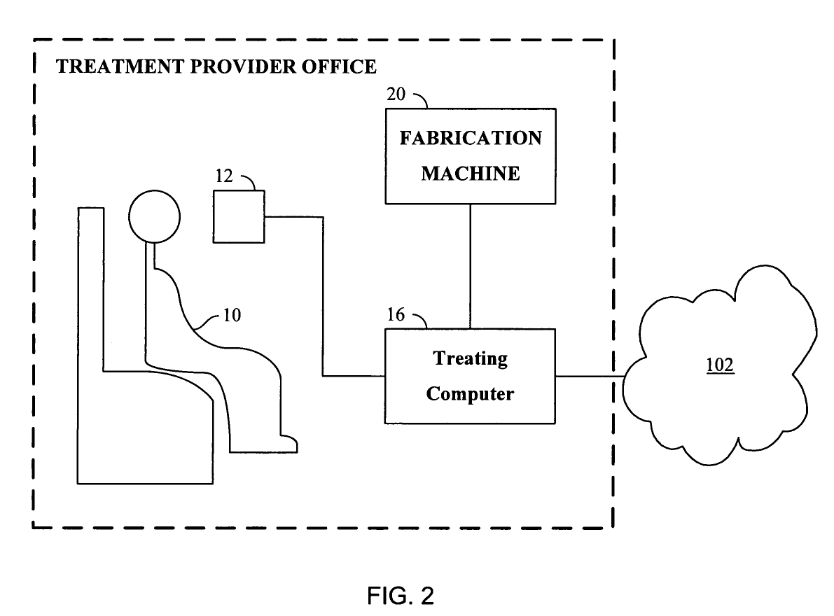

FIG. 2 shows an exemplary system for performing mass customization. A scanner 12 is used to scan one or more physical objects 10, which in this example is a patient's teeth. Although teeth is used as an example, the physical objects 10 can be other anatomical objects as well, including ear canals, hands, feet, among others. The physical objects 10 can also be engineered objects such as eye glasses, cellular telephones, and computers, for example.

The scanner can be an MRI scanner, a CT machine, an X-Ray machine, or an intra-oral scanner, for example. In applications that treat the masticatory system of the patient, the scanner 12 can scan the patient's teeth, soft issue, or both. In one embodiment where the scanner 12 is an intra-oral scanner, masticatory data is uploaded to a computer 16 that performs, among others, generating a computer representation of the masticatory system of the patient; and determining an occlusion from the computer representation of the masticatory system. The computer 16 drives a fabrication machine 20 to generate one or more physical objects, in this case appliances to treat the patient's teeth in accordance with the determined occlusion. The computer 16 is also connected to a wide area network such as the Internet 102 to access ancillary services and information, among others.

The scanner 12 generates 3D volumetric data set of the object 10. The scanned data is processed by the computer 16 using software tool to cut, trim, transform and otherwise manipulate the digitized objects. In one implementation, the software can generate 3D visualizations of the object 10 in connection with its intended environment. For example, in the dental environment discussed above, an image of the patient can be merged with 3D renderings of the suitably transformed digital models to arrive at a composite view of the transformed digital model and its environment (in this case the patient's face). Such visualization capabilities allow a treatment provider to review and discuss the proposed treatment with the patient. In another embodiment, the software can process the scanned data and provide the user/operator with useful data and orthodontic measurements (e.g. arch width, arch length, tooth size, angulations) to assist the operator and or patient in fine tuning the treatment plan. The computer can then provide the operator with options in staging the treatment from one stage to another stage, or it can completely generate all stages ranging the initial to final desired stage. The staging can be done automatically by data mining the existing cases currently in a treatment database or by providing the operator with several feasible options using pattern recognition.

Once the digital transformations of the objects have been completed, the data can then be transferred to the fabrication machine 20 to fabricate the physical objects. In one embodiment, the generated objects can be dental appliances such as those described in U.S. Pat. No. 1 6,318,994 entitled “Tooth path treatment plan”, U.S. Pat. No. 6,309,215 entitled “Attachment devices and method for a dental appliance”; U.S. Pat. No. 6,299,440 entitled “System and method for producing tooth movement”; U.S. Pat. No. 6,227,851 entitled “Manipulable dental model system for fabrication of a dental appliance”; U.S. Pat. No. 6,227,850 entitled “Teeth viewing system”; U.S. Pat. No. 6,217,325 entitled “Method and system for incrementally moving teeth”; U.S. Pat. No. 6,210,162 entitled “Creating a positive mold of a patient's dentition for use in forming an orthodontic appliance”; and U.S. Pat. No. 5,975,893 entitled “Method and system for incrementally moving teeth”, the contents of which are hereby incorporated by reference.

The fabrication machine 20 for fabricating aligners can employ the following exemplary technologies/methods:

1- Milling the objects out of block of polymeric material

2- Thermal forming; 1) fabricate a prototype of the arch, 2) thermal form a sheet of polymer over it, and 3) cut, trim & polish it using laser and/or milling machine and polishing wheels or a tumbling unit.

3- Using shelling technique to rapid prototype (SLA) the objects from a biocompatible resin

4- Thermal set; 1) fabricate a prototype of the arch, 2) apply thermal set material over it, and 3) once the material set, cut, trim and polish it using laser and/or milling machine and polishing wheels or a tumbling unit.

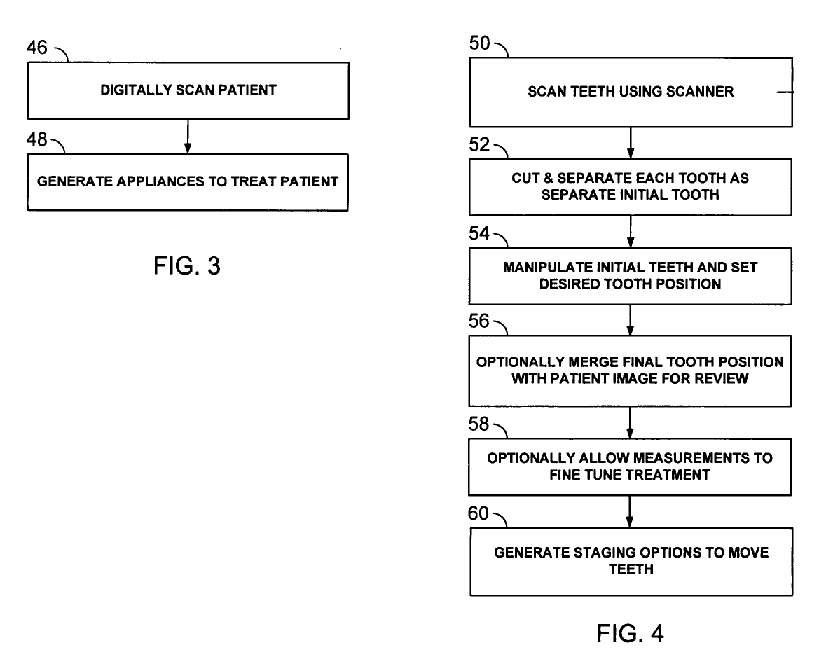

The system can be centralized for high speed production, or can be localized for quick turn-around. FIG. 3 shows one embodiment for treating the patient at the professional's office. The process of FIG. 1C first digitally scans the patient at the treatment provider's office (46) and generates at the treatment provider's office one or more appliances to treat the patient (48).

FIG. 4 shows another embodiment for treating the patient's teeth at the professional's office. First, the scanner 12 can acquire images of the inner arch, determine the occlusion (50), and based on that the computer 16 separates each tooth object for both the upper and lower arch (52). At that point the doctor could use the software to move the tooth objects so that the final position of the occlusion satisfies the desired prescription of the doctor (54). Optionally, the system can merge the final position of the tooth objects with a patient image for preview purposes (56). As another option, the system allows the user to measure teeth data for treatment planning purposes (58). The computer 16 then generates stages required to treat the teeth (60). Once that is done the computer 16 drives the fabrication machine 20 to generate the aligners. Alternatively, the computer system 16 can send data over the wide area network 102 to a remove system that is capable of fabricating the aligner either to thermal forming means or directly to a 3-D printer that could shell the aligner or milling system that could fabricate the aligners. Alternatively, the system can generate indirect bonding templates and retainers.

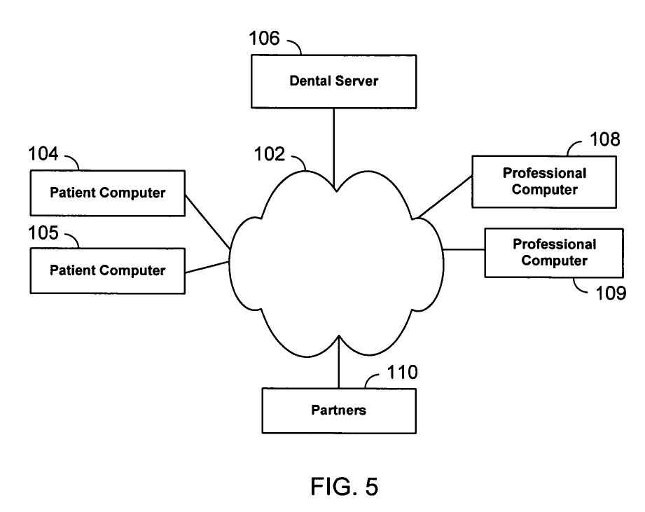

Referring now to FIG. 5, an environment supporting mass-customization is shown. The system communicates over a network 102 that can be a local area network or a wide area network such as the Internet. One or more client computers 104-105 can be connected to the network 102. In one embodiment where the network 102 is the Internet, the client computers execute a suitable browser such as Navigator from Netscape, Inc. and Internet Explorer from Microsoft Corp. By clicking on the highlighted text (or specific graphic image), the user can jump from the current web page to a new web page address associated with the link—with the new page displayed on the screen. In this manner, the user can “surf the web” by clicking on an almost endless succession of links going to page after page all following a common thread as defined by the text or graphic component of the link label.

Through the network 102, the client computers 104-105 can access a server 106. The server 106 serves a web site, a portal, a vortal, or a content site for providing information to interested parties. Thus, for the dental example, the interested parties can include dental patients, dentists, orthodontists, and others. When sensitive information is communicated through the server 106, such information is securely encrypted using Secure Sockets Layer (SSL) technology throughout the transaction. The server 106 can be a stand-alone computer or can be a server farm that can distribute processing and communications activity across a computer network so that no single device is overwhelmed. During load balancing, if one server is swamped with requests, excess requests are forwarded to another server with more capacity.

The network 102 connects the server 106 to one or more treatment provider workstations 108-109. The workstations 108-109 allow treatment providers access to a plethora of services provided by the server 106 such as patient treatment and office management, among others. The server 106 stores information associated with patient history on-line in a secure manner. The server 106 also allows the treatment provider to have a comprehensive view of the patient's treatment history at any time using a suitable browser, eliminating the need to pull treatment files or charts or to look for misfiled or lost charts. The server 106 also provides treatment providers with tools to analyze patient data, for example, tools to reconstruct a 3D model of the teeth. For example, using the browser, the treatment provider can request the server 106 to animate the progress of the treatment plan. When the treatment provider arrives at a prescription or other final designation, the treatment prescription is used to automatically generate appliances, as described in more details below. Further, in addition to aiding professionals in treating professionals in treating patients, the treatment provider can perform office management, purchasing and other logistical operations using the browser and the server 106.

In addition to communicating with patients and treatment providers, the server 106 can communicate with one or more partners 110 using the network 102. The partners 110 can be product suppliers, service providers, or any suitable commercial entities.

One partner 110 can be a financing partner that offers customers with one or more electronic financing options. In one implementation, the financing partner can be a credit card processing company. The credit card processing company can accept a customer's existing credit card or can issue the customer with a new credit card. Further, the credit card can be issued under the name of a third-party bank, the name of the credit card processing company, or the name of the site supported by the server 106 under a co-branding arrangement.

The customer enters the sensitive data such as credit card number, shipping address, among others, onto a purchase form. The credit data is then submitted, collected and passed securely through the server 106. This data can be processed in real time or can be collected by mail or telephone and then entered by an operator. A processor at the credit card processing company then verifies that the credit card number is valid and is not stolen, among other anti-fraud measures. If the credit card information is valid, the purchase price will be reserved from the issuing bank of the consumer's credit card and allocated to the account associated with the server 106. Periodically, the credit card processor settles all accounts; it is at this time that all monies move. Funds reserved are transmitted from the issuing bank of the cardholder's credit card to the account of the server 106. Also, discount fees are paid from these funds, as they are moving.

Alternatively, the financing partner can debit from the customer's checking account over the Internet. One such check debiting services is the Merchan Trust™ Paperless Checks™ Services, available from Merchant Commerce, Inc. These services provide customers with the convenience of making online purchases by checking account debits, with no manual data entry required of a merchant. In this embodiment, a customer fills in a form at the site with bank information printed at the bottom of his or her personal check. The information is processed as an Electronic Funds Transfer (EFT) to the customer's account using the Automated Clearinghouse (ACH) payment system.

Yet another possible partner 110 is a dental supply retailer providing an on-line shop on the web site to retail dental products to the customers and treatment providers. The retailer can be a co-branding partner that uses the brand name linked or suitably associated with the web site of the server 106 such that users of the server 106 would not know that the on-line shop is actually operated by a third party. The retailer can offer dental products for brushing, flossing, and cleaning of dental implants and bridges. Other dental products include anti-plaque rinse and plaque-fighting toothpaste. The retailer can also sell other health-care-related products such as prescription drugs; non-prescription drugs; personal care; beauty and spa; vitamins, herbs and nutrition; and medical supplies. Additionally, the retailer can serve the needs of the treatment providers by offering products such as brackets, buccal tubes, bands, archwire products, bonding adhesives, hand instruments, systems, supplies and equipment.

Yet another partner 110 can be a shipping partner. The shipping partner delivers dental supply or goods received from a multiplicity of producers and manufacturers for ultimate distribution to each customer. The facilities for warehousing and introduction of goods into a transportation stream for redistribution are the so-called cross docking facilities. The supply or good flows in bulk from a producer or a manufacturer to one or more cross docking facilities owned by either the shipping partner or the operator of the server 106. The items are then be broken into smaller unit sizes and distributed to the customers.

The above list of partners lists only exemplary partners and is not an exhaustive list. Other possible partners include value-added service providers such as third party software providers who provide plug-in viewing and diagnostic enhancements that can be used by the professionals. The server 106 can perform dynamic targeting and information gathering. The users provide demographic information when they register for our service.

The server 106 can track our users' behavior the entire time they are online. As a result, the server 106 can deliver targeted advertisements and measure their effectiveness. For example, users can receive ads from a brokerage firm when they are viewing sites containing stock quotes or financial news, or receive promotions from a bookseller when browsing sites containing book reviews. As such, the server 106 can provide a prominent and sustained advertising medium to the community. In contrast to most portal and content sites which display advertising, the site remains with users the entire time they are online. Once users are logged on, the site remains in full view throughout the session, including when they are waiting for pages to download, navigating the Internet and even engaging in non-browsing activities such as sending or receiving e-mail. The constant visibility of the site allows advertisements to be displayed for a specified period of time.

In combination, the server 106 forms a hub that links dental clients using client computers 104-105, treatment providers using workstations 108-109, and partners 110 into a living electronic commerce (e-commerce) community.

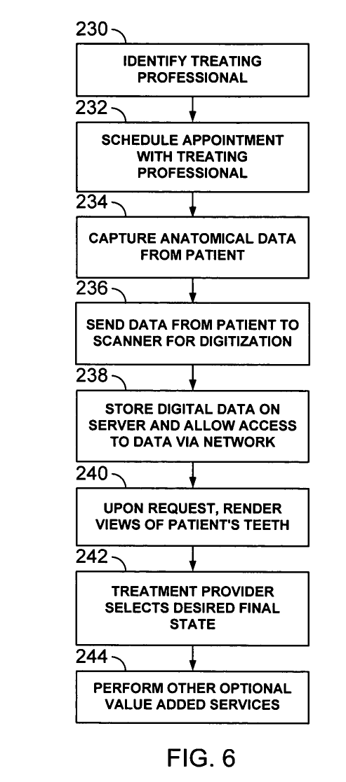

FIG. 6 illustrates an exemplary usage of the dental embodiment from a patient's perspective. First, a prospective client using a client computer 104 visits the web site on the server 106 and identifies a treatment provider meeting one or more criteria, for example a professional whose location is closest to his or her home address (step 230). Next, the patient schedules an appointment with the treatment provider (step 232). At the meeting, an assistant captures various anatomical data from the patient by taking digital photographs of the face and teeth, taking x-rays of the front, back, side, and top/bottom of the patient, taking one or more impressions, among others (step 234). Next, this information is entered into a form on the server 106 (step 236). The data is then digitized, stored on the server 106, and made available to the treatment providers over the Internet (step 238). Next, the server 106 and one or more orthodontic treating persons process the patient data and render the patient's teeth in a plurality of alternative final states (step 240). Based on the choices, the treatment provider selects a desired final state (step 242).

In addition to performing orthodontic operations, the server 106 can also perform other value-added services. For example, processes executed by the server 106 can simulate the color of the patient's enamel and show the color of the teeth before and after bleaching (step 244).

Other optional processes on the server 106 can simulate the color of the patient's silver fillings (amalgram) and show the teeth after cosmetic work to cover the amalgam. After visualizing the effects of the operations, comparing the before and after operations, and reviewing guideline pricing for the orthodontic operation as well as add-ons such as bleaching, the treatment provider makes a decision. Once the treatment provider has accepted a particular treatment selection, the server 106 offers the treatment provider with one or more financing options from one of its financial partners. Additionally, the server 106 can guide the patient to an on-line shopping store to purchase products relating to his or her patients dental health. For example, the treatment provider can buy cleaning supplies, brushes, and flossing supply at a price competitive to his or her traditional stores. Moreover, the products can be delivered to the treatment provider using one or more delivery partners at a convenient time.

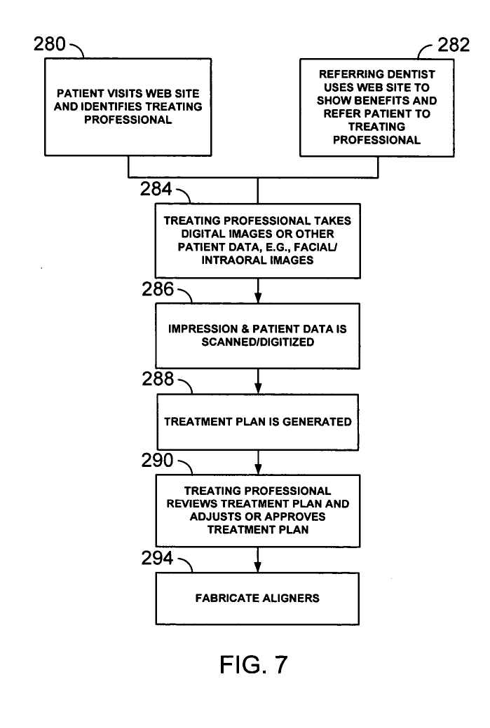

FIG. 7 illustrates an exemplary usage of the system of FIG. 1 from a treatment provider's perspective. A prospective patient uses a client computer 104 and visits the web site on the server 106 (step 280). The client identifies a treatment provider and schedules an appointment with the treatment provider (step 281). Alternatively, a referring dentist can refer the client to the treating orthodontist (step 282). The referring dentist can visit the web site on the server 106 and uses one or more dental esthetic tools to show patients the potential benefits of anterior and posterior esthetic restorations and, if the patient is interested, refers the patient to the treatment provider (step 283).

During an initial examination, the treatment provider or an assistant takes a set of digital facial and intraoral images which is uploaded to a secure, collaborative workspace on the server 106 (step 284). The workspace is shared with the referring dentist.

Next, the treatment provider generates a dentofacial treatment visualization showing the patient's face and smile before and after treatment (step 286). The treatment provider can also combine the patient's face and an aligner into the intraoral image to show how the inconspicuous the appliance will be (step 288).

Once the patient requests treatment, the treatment provider takes impressions and a bite registration and sends the information to the company (step 290). The treatment provider also takes a lateral ceph and a panorex and uploads them and a treating prescription to the workspace (step 292). The professional's assistant creates a separate workspace for the patient, uploads selected “before and after” images into it, and invites the patient to review the images (step 294).

At the company, another professional reviews the records and decides to accept or decline the case. The models are then scanned, and the intraoral images are retrieved and used to texture-map enamel and gingiva. The data is then sent to the workspace and the treatment provider is notified.

In one embodiment, the tooth models may be posted on a hypertext transfer protocol (http) web site for limited access by the corresponding patients and treating clinicians. Since realistic models have a large volume of data, the storage and transmission of the models can be expensive and time consuming. To reduce transmission problems arising from the large size of the 3D model, in one embodiment, data associated with the model is compressed. The compression is done by modeling the teeth meshes as a curve network before transmission to the treatment provider. Once the curve network is received, the 3D model is reconstructed from the curve network for the treatment provider to analyze. More information on the compression is disclosed in a co-pending application having Ser. No. 09/506,419, entitled, “EFFICIENT DATA REPRESENTATION OF TEETH MODEL”, and filed by ELENA PAVLOVSKAIA and HUAFENG WEN on Feb. 17, 2000, the contents of which are hereby incorporated.

The treatment provider can, at his or her convenience, check the setup, and review the information. The treatment providers can use a variety of tools to interpret patient information. For example, the treatment provider can retrieve and analyze patient information through a reconstructed 3D model of the patient's teeth and other anatomical structures. The professional can view animations showing the progress of the treatment plan to help the treating physician visualize the pace of treatment. Using these tools, the treatment provider can easily and quickly view and/or edit the treatment plan.

If necessary, the treatment provider can adjust one or more teeth positions at various intermediate stages of treatment. A variety of diagnostic decision-support capabilities such as automated teeth collision detection can be used to aid the treatment provider in adjusting the teeth positions.

When the treatment provider arrives at a prescription or other final designation, the treatment information is automatically collected by the system over the Internet, thus eliminating the cost and delay associated with the traditional physical shipping of patient information. These modifications are then retrofitted onto the dataset used to generate the appliances or aligners.

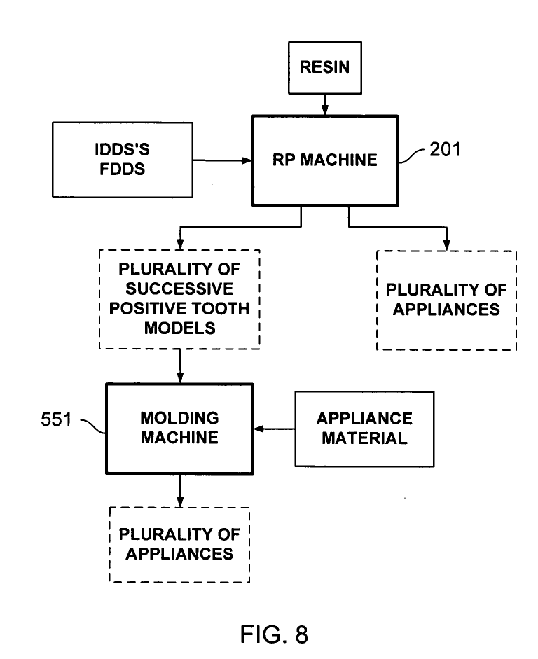

The appliances can also be fabricated at a central facility as illustrated in FIG. 8. Common fabrication methods employ a rapid prototyping device S/B 501 such as a stereolithography machine. A particularly suitable rapid prototyping machine is Model SLA-7000 available from 3D Systems, Valencia, Calif. The rapid prototyping machine 501 selectively hardens a liquid or other non-hardened resin into a three-dimensional structure which can be separated from the remaining non-hardened resin, washed, and used either directly as the appliance or indirectly as a mold for producing the appliance. The prototyping machine 501 receives the individual digital data sets and produces one structure corresponding to each of the desired appliances. Generally, because the rapid prototyping machine 501 may utilize a resin having non-optimum mechanical properties and which may not be generally acceptable for patient use, the prototyping machine typically is used to produce molds which are, in effect, positive tooth models of each successive stage of the treatment. After the positive models are prepared, a conventional pressure or vacuum molding machine 551 is used to produce the appliances from a more suitable material, such as 0.03 inch thermal forming dental material, available from Tru-Tain Plastics, Rochester, Minn. 55902. Suitable pressure molding equipment is available under the trade name BIOSTAR from Great Lakes Orthodontics, Ltd., Tonawanda, N.Y. 14150. The molding machine 551 produces each of the appliances directly from the positive tooth model and the desired material. Suitable vacuum molding machines are available from Raintree Essix, Inc.

After production, the appliances can be supplied to the treatment provider all at one time. The appliances are marked in some manner, typically by sequential numbering directly on the appliances or on tags, pouches, or other items which are affixed to or which enclose each appliance, to indicate their order of use. Optionally, written instructions may accompany the system which set forth that the patient is to wear the individual appliances in the order marked on the appliances or elsewhere in the packaging.

The system delivers customer value management (CVM), a business model that combines e-commerce, customer relationship management (CRM) and mass customization technologies. The system manages all parts of the organization that deal with the customer. This approach opens the traditional back office, production operations and the upstream supply chain to the customer. The system allows customers to gather information, make selections, custom-design products, negotiate discounts, check on delivery schedules and ask for service.

The invention has been described in terms of particular embodiments. Although teeth treatment is discussed, the invention can be used to generate prosthesis for patients, among others. Other embodiments are within the scope of the following claims.

What is claimed is:

1. A method for mass-customizing a product fitting a first object, comprising:
a. Generating a virtual model of the first object;
b. altering the virtual model to generate a transformed virtual model; and
c. Generating a second physical object from the transformed virtual model

2. The method of claim 1, wherein the generating a virtual model further comprises scanning the first object.

3. The method of claim 2, wherein the scanning comprises receiving data from one of the following: an MRI scanner, a CT scanning machine and an X-ray machine.

4. The method of claim 1, further comprising:
generating an image of the virtual object in its desired position; and
merging the image of the virtual object in its desired position with an image of the object's target environment.

5. The method of claim 1, further comprising allowing measurements to the virtual object.

6. The method of claim 1, further comprising milling the second physical object from a polymeric material.

7. The method of claim 1, further comprising thermal the second physical object.

8. The method of claim 1, further comprising:
thermal forming a sheet polymer to form the second physical object; and preparing the second physical object for use.

9. The method of claim 1, further comprising cutting, trimming and polishing the second physical object.

10. The method of claim 1, wherein the second physical object is prepared using a laser machine.

11. The method of claim 1, wherein the second physical object is prepared using a milling machine.

12. The method of claim 1, further comprising shelling a negative of the second physical object.

13. The method of claim 1, further comprising shelling a positive of the second physical object.

14. The method of claim 1, further comprising shelling the second physical object from a bio-compatible resin.

15. The method of claim 1, further comprising thermal setting the second physical object.

16. The method of claim 1, further comprising:
applying a thermal set material to form the second physical object; and preparing the second physical object for use.
